(19) United States
(12) Patent Application Publication
(10) Pub. No.: US 2002/0022756 A1
(43) Pub. Date: Feb. 21, 2002

(54) Process for reduction of bioaccessibility of heavy metals

(76) Inventors: Ajit Chowdhury, Madison, WI (US); Thomas R. Stolzenburg, Madison, WI (US)

Correspondence Address: Bennett J. Berson, Quarles & Brady LLP, 1 South Pinckney Street, P O Box 2113, Madison, WI, 53701-2113, US

(21) Appl. No.: 09/832,078

(22) Filed: Apr. 10, 2001

Related U.S. Application Data
(60) Provisional application No. 60/195,924, filed on Apr. 10, 2000.

(51) Int. Cl. A62D 3/00

(52) U.S. Cl. 588/15; 588/223

(57) ABSTRACT

A method for reducing leaching and bioaccessibility of a heavy metal from particulate matter includes the steps of treating the particulate matter with phosphate, chloride and iron additives; wetting the additive-containing particulate matter with water; and incubating the particulate matter at a temperature above ambient temperature for a time sufficient to achieve the goals of the invention.

### CROSS-REFERENCE TO RELATED APPLICATIONS

This application claims the benefit of U.S. Provisional Patent application Ser. No. 60/195,924, filed Apr. 10, 2000, the disclosure of which is incorporated herein by reference in its entirety as if set forth herein.

### STATEMENT REGARDING FEDERALLY SPONSORED RESEARCH OR DEVELOPMENT

Not applicable.

### BACKGROUND OF THE INVENTION

The present invention relates to methods for reducing leachability and bioaccessibility of heavy metals-contaminated particulate matter. Heavy metals, such as lead, cadmium, zinc and copper, are commonly present in the environment in chemical forms that are bioavailable and toxic to mammals. Upon ingestion of lead-contaminated particulate matter, lead solubilizes in the gastric solution in the gastrointestinal (GI) tract as it metabolizes in the mammal's body. A fraction of the solubilized lead is absorbed into the systemic circulation (i.e., blood), exerting its toxicity. The fraction of total ingested lead that is solubilized in the GI tract is defined as the “bioaccessible fraction,” whereas the fraction of dissolved lead that is absorbed into systemic circulation is defined as the “bioavailable fraction.” A reduction of the bioaccessibility of lead will reduce its bioavailability and, therefore, its biotoxicity.

The tests used to determine the bioavailability of metals generally include the following:

1. oral dosing study of immature swine—in vivo testing;

2. oral and intravenous (for soluble lead) dosing study of Sprague-Dawley rats—in vivo testing

3. in vitro screening tests (not using animals) to estimate bioavailability or bioaccessibility simulating a gastrointestinal tract parameter representative of a human

In vivo tests, by their very nature, are time-consuming and expensive. In vitro tests are comparatively easier to perform and are more desirable for screening stabilization treatment strategies and their effectiveness. However, U.S. EPA has not approved any in vitro screening test procedures to evaluate bioavailability quickly. The behavior of a heavy metal in regulatory test such as the U.S. EPA Toxicity Characteristic Leaching Procedure (TCLP), Synthetic Precipitation Leaching Procedure (SPLP), and ASTM Water Leach Test, or aqueous solubility of lead from the metal-contaminated particulate matter, is not indicative of its bioavailability.

The best known in vitro test procedure is the physiologically-based extraction test (PBET) disclosed by Ruby et al. (ES&T .30(2) 422-430, 1996), which generally shows good correlation with side-by-side in vivo results, particularly for lead. In the PBET procedure (1) test material such as soil is subjected to simulated stomach conditions by being incubated at a ratio of 0.4 g soil to 40 mL gastric solution for 1 hour at a pH of 1.3 to 4.0 (to reflect fasting, average, and fed states of gastric solution) at 37° C., and (2) the incubated test material is neutralized with sodium bicarbonate to pH 7.0 and then contacted with bile salts, etc., for 4 hours to simulate small intestine transit of ingested material. The pH of gastric solution is measured first after 5 minutes of extraction and every 10 minutes thereafter, and the pH is adjusted with HCl, as necessary. A gastric solution pH of 1.3 in the stomach provides a leaching media that is substantially more aggressive than the leaching solution in any of the above-mentioned procedures.

The known processes for stabilizing heavy metals to control metal leaching do not include processes for rendering metal-contaminated particulate matter nonbioavailable so as to provide relief from the toxic effects of the metal when ingested by a mammal or other living beings.

U.S. Pat. No. 5,931,773 discloses using a combination of various additives with contaminated materials in waste or solids containing high levels of heavy metals such as lead to reduce the permeability of the waste and the leaching of the heavy metals into the ground water. The patent does not disclose or suggest conditions suitable for reducing bioaccessibility and bioavailability of heavy metals.

### BRIEF SUMMARY OF THE INVENTION

The present invention provides a process for reducing the leaching potential and the bioaccessibility of heavy metals, particularly lead, wherein metal-contaminated particulate matter is reacted under controlled conditions with a mix of chemical additives that include phosphate, chloride, iron, an alkaline material, and moisture. The reactants combine with the metal(s) to promote formation of metal chloropyromorphite, particularly lead chloropyromorphite, one of the least soluble lead compounds known, in a wide range of pH conditions. The reaction occurs in minutes at temperatures higher than ambient temperature. However, the chemistry is effective at ambient temperatures when sufficient reaction time (hours or days, depending on the desired bioaccessibility reduction levels) is allowed for the reaction to occur. At a temperature at least 10° C. above ambient temperature, the bioaccessibility is reduced by at least 50% after a one day incubation, and by at least 70% after 3 days, and by at least 80% after 5 days.

The treatment process uses commercially available treatment chemicals and equipment and is, therefore, easily implemented in full-scale applications.

It is an object of the invention to provide a method for treating heavy metal-contaminated particulate matter such that the bioaccessibility of the heavy metal or metals is reduced after treatment.

It is a feature of the present invention that treatment is achieved at a temperature above ambient temperature.

It is another feature of the invention that the particulate matter is wetted with water during treatment.

It is an advantage of the invention, in addition to any other advantages associated with treating the heavy metal contamination, that the reduced bioaccessibility achieved in the method has not heretofore been shown in existing methods for reducing permeability of particulate matter or for reducing heavy metal leaching.

Other objects, features and advantages of the invention will become apparent upon consideration of the following detailed description.

### BRIEF DESCRIPTION OF THE SEVERAL VIEWS OF THE DRAWING

Not applicable.

### DETAILED DESCRIPTION OF THE INVENTION

According to the present invention, bioaccessibility can be reduced by contacting the metal-contaminated particulate matter with a phosphate additive, a chloride additive, and an iron additive; the treated matter is then wetted with water and allowed to react at a specified temperature for a desired reaction time. Additionally, an alkali may also be added with the above-noted ingredients or after the initial reaction is complete. It can be preferred to add the alkali after the initial reaction is complete so that even though the reaction occurs at low pH, pH can be returned to a neutral range (pH 6-8) to facilitate handling of the treated waste.

The metal-contaminated particulate matter amenable to this treatment process can include, but is not limited to, lead-contaminated soil, sediment, wastes and sludges, or particulate matter from industrial emissions, such as cupola emission control dust, wet scrubber sludge, baghouse dust from metal processing operations, metal-contaminated foundry sand, incinerator fly ash and bottom ash, smelter emission control particulates, lead-contaminated paint chips, electrical cable/wire insulation sheathing, battery chips, and the like.

Chlorides effective in this process include calcium chloride, iron chloride (ferrous or ferric), aluminum chloride, sodium chloride, potassium chloride, or hydrogen chloride. The chloride can be added to the particulate matter at between about 0.1-15% by weight, preferably between about 0.1-10% by weight.

The phosphate can include any ortho-phosphate compound, including triple superphosphate (TSP), single superphosphate, phosphoric acid, polyphosphoric acid, monocalcium phosphate, dicalcium phosphate, tricalcium phosphate, sodium phosphates (mono-, di-, or tri-), potassium phosphate, synthetic hydroxyapatite, naturally occurring fluorapatite or hydroxyapatite, or phosphate rock. The phosphate can be added to the particulate matter in an amount between about 0.1 and 15% by weight, preferably between about 3 and 12%. The amount of phosphate provided should generally be at least comparable to the amount of chloride (by molar ratio).

The iron can be added in the process as elemental or zero-valent iron, and iron compounds, including ferrous chloride, ferric chloride, ferrous sulfate, ferric sulfate, ferrous nitrate, ferric nitrate, iron-containing pickle liquors from metal processing operations, or iron oxide. Alternatively, hydrochloric acid-based pickle liquors may be used as a source of both chloride and iron. The iron can be added to the particulate matter in an amount between about 0.1 and 15% by weight, preferably between about 2 and 5%.

The alkali can be magnesium oxide, magnesium hydroxide, high calcium or dolomitic quick lime, hydrated lime, limestone, reactive calcium carbonate, lime kiln dust, sodium silicate, sodium aluminate, cement, cement kiln dust, sodium hydroxide, sodium carbonate, sodium bicarbonate, potassium hydroxide, potassium carbonate, potassium bicarbonate, and alkaline soil or any lime-containing material including, but not limited to, industrial by-products such as carbide slag, desulfurization slag, lime water softening sludge, and the like. The alkali can be added to the particulate matter at between about 0.1-15% by weight, preferably between about 1-3%.

The list of agents mentioned is not to be considered exhaustive. Rather, the skilled artisan is able to select appropriate agents from the wide range of such agents known to the art.

In the method, particulate matter is first mixed thoroughly with the phosphate, chloride, and iron. Water is then added to make a completely wet reaction mix of the metal-contaminated particulate matter and the additives. The wet reaction mix reacts at the desired temperature for a specified reaction time. Typically, the wet reaction mix is acidic, with the pH ranging from 0.1 to 6.0. The additive dosage rate depends on the level of contamination and the matrix in which it is present. A suitable temperature range is from ambient temperature to 90° C., and the reaction time required to complete the reaction may range from a few minutes to months, depending on the reaction conditions and desired treatment effectiveness. Ambient temperature is considered to be about 20-25° C. When the temperature is at least about 10° C. higher than ambient temperature, bioaccessibility is reduced to a greater extent than at ambient temperature. Effective treatment is observed at temperatures of about 30-35° C. and higher. The reaction can be carried out at temperatures above 90° C. under pressure (above the corresponding saturation steam pressure) while keeping the reaction mix humid and wet.

The reduction of the bioaccessibility may be carried out in situ for subsurface treatability or ex situ for industrial waste streams. For in situ applications, the reactants may be mixed with the lead-contaminated material by tilling or mixing in place with backhoes, screw augers, or trenchers and the like. The mixed material may be heated by adding hot water or steam and then covering with a clear plastic sheet for solar heating, or it may be heated electrically. Alternatively, for surface soil treatment application, any grass, leaves, etc., may be tilled in; and then additional humus materials and nutrients, such as manure, may be added along with the chemical additives. The mixture may then be covered to promote composting to provide the desired elevated temperatures. Ex situ heating may be accomplished by direct steaming or by indirect heating (with steam coils, etc.) of the reaction mixture in a pug mill, muller, cement mixer, roll-off container, slurry tank reactor, or similar mixing equipment.

The invention will be more fully understood upon consideration of the following examples which are not considered to limit the scope of the invention.

### EXAMPLES

Bioaccessibility reduction of lead-contaminated soil

Lead-contaminated soil containing 1,500 mg/kg lead, 60 mg/kg arsenic, and 30 mg/kg cadmium was treated according to the process of the present invention with varying additive mixes and dosages incorporating phosphate, chloride, iron, and alkali.

A simplified screening PBET procedure, using a synthetic gastric solution pH of 1.3, was used to conservatively estimate bioaccessibility reduction after various soil treatments. The simplified procedure also included digestion in simulated gastric fluid in a beaker with a magnetic stirrer on a hot plate, as opposed to digestion in a separatory funnel placed in a hot water bath and mixing by bubbling argon gas prescribed in the PBET procedure. Since the gastric fluid extraction provided significantly more aggressive leaching conditions, the screening PBET procedure included only this gastric fluid extraction for bioaccessibility assessment. No extraction with bile salts was carried out. The chemical composition of the gastric solution and the digestion time were as prescribed in the PBET procedure.

All of the treatment additives were added at the dosages indicated in Table 1, except the alkali. The percentages of the additives are considered exemplary and not limiting on the scope of the invention. The mixture was kept dry or wetted with water and incubated at the specified temperature for the desired reaction time. MgO (alkali) was then added to the soil prior to performing the screening PBET for lead. Alternatively, MgO can be added to the reaction mix along with the other treatment chemicals, but this is less preferred as the treatment method proceeds more efficiently at strongly acidic pH levels. The results on the PBET extracts after treatment are presented in Table 1. The presence or absence of CaCl₂ in the example of Table 1 appears to have little bearing upon the effectiveness of the method (compare Rows 6 and 7). On the other hand, in that example, substitution or addition of FeCl₃ (which contributes both iron and chloride) enhances bioaccessibility reduction relative to a treatment lacking iron), even under dry conditions (compare Rows 3 and 4, and Rows 5, 6 and 7).

The PBET extract results show that the lead bioaccessibility of the lead-contaminated soil was reduced substantially in comparison to the untreated soil after treatment with a combination of chemicals containing phosphate, chloride, iron, and alkali and treating the mix as disclosed. The results in Table 1 also demonstrate a real and unexpected difference between treatment of the waste under dry conditions as opposed to treatment when the waste is wet (ranging from a damp wet to the touch to a slurry consistency) and the temperature is raised above ambient temperature. For example, when rows 4 and 6 are compared it is apparent that while a 12.5% reduction in bioaccessibility is observed under dry conditions, the same chemical treatment under saturated conditions at 50° C. nets a 70% bioaccessibility reduction relative to control, untreated samples.

The preceding description is not intended to limit the invention, the scope of which is determined only by the appended claims, including all such variations and modifications as are apparent to the skilled artisan.

TABLE 1
Lead-contaminated Soil Treatment for Bioaccessibility Reduction

| | | | | SCREENING | | LEAD | |
|---|---|---|---|---|---|---|---|
| | | | | PBET RESULTS | | BIOACCESSIBILITY | |
| | | | REACTION | CADMIUM | LEAD | REDUCTION (%) | |
| TEST ID | ADDITIVE DOSAGE (WT %) | MOISTURE | CONDITIONS | (mg/L) | (mg/L) | CADMIUM | LEAD |
| 1 | None (untreated/control) | Dry | Ambient temp (20° C.) | 0.2 | 16.0 | — | — |
| 2 | 10% TSP + 2.5% MgO | Dry | Ambient temp (20° C.) | 0.17 | 13 | 15.0 | 18.8 |
| 3 | 10% TSP + 5% CaCl₂ + 2.5% MgO | Dry | Ambient temp (20° C.) | 0.17 | 14 | 15.0 | 12.5 |
| 4 | 10% TSP + 5% FeCl₃ + 2.5% MgO | Dry | Ambient temp (20° C.) | 0.14 | 10 | 30.0 | 37.5 |
| 5 | 10% TSP + 5% CaCl₂ + 2.5% MgO | Saturated | 5 Days at 50° C. | — | 14 | — | 12.5 |
| 6 | 10% TSP + 5% FeCl₃ + 2.5% MgO | Saturated | 5 Days at 50° C. | — | 4.8 | — | 70.0 |
| 7 | 10% TSP + 5% CaCl₂ + 5% FeCl₃ + 2.5% MgO | Saturated | 5 Days at 50° C. | — | 4.2 | — | 73.8 |
| 8 | 4% TSP + 2% CaCl₂ + 2% FeCl₃ + 1% MgO | Saturated | 1 Day at ambient | — | 9.2 | — | 42.5 |
| | | | temperature | | | | |
| 9 | 4% TSP + 2% CaCl₂ + 2% FeCl₃ + 1% MgO | Saturated | 3 Days at amb. temp. | — | 8.9 | — | 44.4 |
| 10 | 4% TSP + 2% CaCl₂ + 2% FeCl₃ + 1% MgO | Saturated | 8 Days at amb. temp. | — | 7.1 | — | 55.6 |
| 11 | 4% TSP + 2% CaCl₂ + 2% FeCl₃ + 1% MgO | Saturated | 1 Day at 35° C. | — | 7.1 | — | 55.6 |
| 12 | 4% TSP + 2% CaCl₂ + 2% FeCl₃ + 1% MgO | Saturated | 3 Days at 35° C. | — | 4.0 | — | 75.0 |
| 13 | 4% TSP + 2% CaCl₂ + 2% FeCl₃ + 1% MgO | Saturated | 8 Days at 35° C. | — | 3.1 | — | 80.6 |
| 14 | 4% TSP + 2% CaCl₂ + 2% FeCl₃ + 1% MgO | Saturated | 1 Day at 50° C. | — | 4.7 | — | 70.6 |
| 15 | 4% TSP + 2% CaCl₂ + 2% FeCl₃ + 1% MgO | Saturated | 3 Days at 50° C. | — | 2.5 | — | 84.4 |
| 16 | 4% TSP + 2% CaCl₂ + 2% FeCl₃ + 1% MgO | Saturated | 6.2 Days at 50° C. | — | 2.2 | — | 86.3 |

1. A method for reducing bioaccessibility of a heavy metal in metal-contaminated particulate matter, the method comprising the steps of:
treating the particulate matter with a phosphate additive, a chloride additive, and an iron additive;
wetting the additive-containing particulate matter with water;
incubating the wet, additive-containing particulate matter at a temperature above ambient temperature for a time sufficient to reduce the bioaccessibility of the heavy metal.

2. A method as claimed in claim 1 wherein the phosphate additive is an ortho-phosphate compound.

3. A method as claimed in claim 1 wherein the phosphate additive is selected from the group consisting of triple superphosphate, single superphosphate, phosphoric acid, polyphosphoric acid, monocalcium phosphate, dicalcium phosphate, tricalcium phosphate, monosodium phosphate, disodium phosphate, trisodium phosphate, potassium phosphate, synthetic hydroxyapatite, naturally occurring fluorapatite or hydroxyapatite, and phosphate rock.

4. A method as claimed in claim 1 wherein the phosphate additive is added in an amount between about 0.1% and 15% by weight.

5. A method as claimed in claim 1 wherein the chloride additive is selected from the group consisting of calcium chloride, ferrous chloride, ferric chloride, aluminum chloride, sodium chloride, potassium chloride, and hydrogen chloride.

6. A method as claimed in claim 1 wherein the chloride additive is added in an amount between about 0.1% and 10% by weight.

7. A method as claimed in claim 1 wherein the iron additive is selected from the group consisting of elemental iron and an iron compound.

8. A method as claimed in claim 7 wherein the iron compound is selected from the group consisting of ferrous chloride, ferric chloride, ferrous sulfate, ferric sulfate, ferrous nitrate, ferric nitrate, and iron oxide.

9. A method as claimed in claim 1 wherein the iron additive is added in an amount between about 0.1% and 15% by weight.

10. A method as claimed in claim 1 wherein the iron additive is provided in a hydrochloric acid-based pickle liquor.

11. A method as claimed in claim 1 further comprising in the treating step adding alkali to the particulate matter.

12. A method as claimed in claim 11 wherein the alkali is selected from the group consisting of magnesium oxide, magnesium hydroxide, high calcium quick lime, dolomitic quick lime, hydrated lime, limestone, reactive calcium carbonate, lime kiln dust, sodium silicate, sodium aluminate, cement, cement kiln dust, sodium hydroxide, sodium carbonate, sodium bicarbonate, potassium hydroxide, potassium carbonate, potassium bicarbonate, alkaline soil and a lime-containing material.

13. A method as claimed in claim 11 wherein the alkali is added in an amount between about 0.1% and 15% by weight.

14. A method as claimed in claim 1 further comprising after the incubating step adding alkali to the particulate matter.

15. A method as claimed in claim 14 wherein the alkali is selected from the group consisting of magnesium oxide, magnesium hydroxide, high calcium quick lime, dolomitic quick lime, hydrated lime, limestone, reactive calcium carbonate, lime kiln dust, sodium silicate, sodium aluminate, cement, cement kiln dust, sodium hydroxide, sodium carbonate, alkaline soil and a lime-containing material.

16. A method as claimed in claim 14 wherein the alkali is added in an amount between about 0.1% and 15% by weight.

17. A method as claimed in claim 1 wherein the incubation step is performed at a temperature at least 10° C. higher than ambient temperature.

18. A method as claimed in claim 17 wherein the incubation step is performed at a temperature between about 35° C. and 90° C.

19. A method for reducing bioaccessibility of a heavy metal in metal-contaminated particulate matter, the method comprising the steps of:
treating the particulate matter with triple superphosphate and iron chloride additives;
saturating the additive-containing particulate matter with water;
incubating the saturated, additive-containing particulate matter at a temperature between 35° C. and 50° C. inclusive for a time sufficient to reduce the bioaccessibility of the heavy metal.

20. A method as claimed in claim 19 further comprising adding magnesium oxide to the incubated particulate matter.

21. A method as claimed in claim 19 wherein the triple superphosphate additive is added to the particulate matter at between 4% and 10% inclusive by weight.

22. A method as claimed in claim 19 wherein the iron chloride additive is added to the particulate matter at between 2% and 5% inclusive by weight.

23. A method as claimed in claim 19 wherein the incubation step proceeds for at least one day.

24. A method as claimed in claim 19 wherein the incubation step proceeds for at least three days.

25. A method as claimed in claim 19 wherein the incubation step proceeds for at least 6.2 days.
